(19) United States
(12) Patent Application Publication
(10) Pub. No.: US 2013/0057971 A1
(43) Pub. Date: Mar. 7, 2013

(54) PANORAMIC IMAGING LENS AND PANORAMIC IMAGING SYSTEM USING THE SAME

(71) Applicants: Liefeng ZHAO, Suwon-si (KR); Mikhail Popov, Moscow (RU); Jung-Pa Seo, Gwangmyeong-si (KR)

(72) Inventors: Liefeng ZHAO, Suwon-si (KR); Mikhail Popov, Moscow (RU); Jung-Pa Seo, Gwangmyeong-si (KR)

(73) Assignee: Samsung Electronics Co., Ltd.

(21) Appl. No.: 13/599,382

(22) Filed: Aug. 30, 2012

(30) Foreign Application Priority Data
Sep. 1, 2011 (KR) 10-2011-0088490

(51) Int. Cl. G02B 17/08

(52) U.S. Cl. 359/731

(57) ABSTRACT

Provided is a panoramic imaging lens including a first lens piece and a second lens piece. The panoramic imaging lens realizes reduced complexity and cost of manufacturing, and stray rays causing flare or ghost phenomenon are suppressed by cutting a side of the second lens piece, thereby improving image quality.

### PRIORITY

This application claims priority under 35 U.S.C. §119(a) to a Korean Patent Application filed in the Korean Intellectual Property Office on Sep. 1, 2011 and assigned Serial No. 2011-0088490, the content of which is incorporated herein by reference.

### BACKGROUND OF THE INVENTION

1. Field of the Invention

The present invention relates to a panoramic imaging lens capable of imaging a scene of a 360° azimuth angle and a designed elevation angle to an annular image format, and a panoramic imaging system using the panoramic imaging lens.

2. Description of the Related Art

Panoramic imaging lenses capable of imaging a scene of a 360° azimuth angle at a time, have been disclosed in U.S. Pat. Nos. 4,566,763 to Greguss and 5,473,474 to Powell.

FIG. 1 illustrates the principle of a conventional panoramic imaging lens.

Referring to FIG. 1, a panoramic imaging lens 1 is formed of light permeable materials such as optical glass or a transparent resin, in a rotation symmetrical form around an optical axis O, which is a central axis of the lens 1.

The panoramic imaging lens 1 has a front surface including a first refractive surface or incident surface 2 and a first inner reflective surface 3, and a back surface including a second inner reflective surface 4 and a second refractive surface 5.

The first refractive surface 2 accepts annular rays incident from distant objects of the scene of a 360° azimuth angle and reflects the incident rays to the first inner reflective surface 3 from the second inner reflective surface 4 formed in an annular form that opposes the first refractive surface 2.

The first inner reflective surface 3 located in the center part of the annular first refractive surface 2 reflects the reflected ray from the second inner reflective surface 4 inside the panoramic imaging lens 1 to the second inner refractive surface 5 located in the center part of the annular second inner reflective surface 4.

Then, the second inner refractive surface 5 transfers the reflected ray from the first inner reflective surface 4 to a relay lens part 7 through an aperture 6.

Through the above imaging process in a panoramic imaging system 10 including the panoramic imaging lens 1, the aperture 6, and the relay lens part 7, rays from object points, such as P and Q in FIG. 1, from the object surface will form virtual image points P′ and Q′ by the panoramic imaging lens 1, and then form real image points P″ and Q″ on an imaging surface 8 by the relay lens part 7.

If an image sensor, such as a Charge-Coupled Device (CCD) or a Complementary Metal-Oxide-Semiconductor (CMOS), has been put on the imaging surface 8, a video or still image will be formed, and can be reviewed on the screen.

FIG. 2 illustrates a relationship between a panoramic imaging system shown in FIG. 1 and a formed image.

Referring to FIG. 2, a cylindrical plane perspective is shown, in which the panoramic imaging system 10 has a 360° azimuth field of view and a limited elevation field of view and projects to a flat 2-dimensional image plane with annular image format.

Rays incident from an upper limited elevation angle W1 with respect to an optical axis O of the lens 1 will form image points having an image radius of R1, which is the inner radius of the effective annular image, on the imaging surface 8. Rays from a lower limited elevation angle W2 with respect to the optical axis O of the lens 1 will form image points having an image radius of R2, which is the outer radius of the effective annular image, on the imaging surface 8.

According to the foregoing conventional techniques, the panoramic imaging lens 1 always has two refractive surfaces 2 and 5 and two reflective surfaces 3 and 4.

For enhanced image quality, U.S. Pat. No. 4,566,763 to Greguss discloses a panoramic imaging lens having first and second parabolically-shaped reflective surfaces.

In U.S. Pat. No. 5,473,474 to Powell, a panoramic imaging lens has a concentric axis of symmetry, and includes two refractive surfaces and two reflective surfaces, where the first reflective surface is an aspherical concave conicoid of revolution and the second reflective surface is a convex conicoid, having aspherical parameters depend on the amount of asphericity of the first reflective surface.

As such, the conventional panoramic imaging lenses have four different surfaces in one lens piece, which is a difficult configuration for manufacture.

Furthermore, in the conventional panoramic imaging lenses, two of the four surfaces are aspherical inner reflective surfaces, which must be manufactured by a diamond-cutting machine instead of a much more inexpensive molding machine, thereby increasing costs.

The complexity of the conventional panoramic imaging lens increases production errors, such as surface alignment and aspherical inner reflective surfaces manufacturing errors, which would severely deteriorate the image quality gained by the design with the aspherical inner reflective surfaces.

In order to reduce the manufacturing complexity and cost while increasing the image quality for products, it is important to simplify the configuration of the panoramic imaging lens as much as possible, and correct residual aberrations, such as spherical, astigmatic, chromatic and distortion aberration, and curvature of image field, in the relay lens part when intermediate virtual images formed by the panoramic imaging lens are transferred onto a real image plane.

According to U.S. Pat. No. 6,646,818 to Doi, in the conventional panoramic imaging lens, a part of the ray incident on the ray incident surface 2 of the panoramic imaging lens 1 having two reflective surfaces and two reflective surfaces functions in the manner of a stray ray and causes a flare or ghost phenomenon realization on the imaging element 8.

Such a phenomenon is caused by mixing a part R_{S1}, of an external stray ray R_{S} with a regular imaging ray R_{O} on the ray path of the regular imaging ray R_{O} inside the panoramic imaging lens 1, as illustrated in FIG. 3.

The stray ray R_{S} is incident on the ray incident surface 2 of the panoramic imaging lens 1, and after twice being reflected continuously on the second reflective surface 4 inside the panoramic imaging lens 1, most of the stray ray R_{S} again leaves the lens through the ray incident surface 2. However, the part R_{S1} of the stray ray R_{S} is inwardly reflected on the ray incident surface 2 inside the panoramic imaging lens 1 and propagates along the ray path of the regular imaging ray R_{O} inside of the lens.

Therefore, the part R_{S1} of the stray ray R_{S} is inwardly reflected on the ray incident surface 2, reaches the imaging element 8 along the ray path of the regular imaging ray R_{O}, and is projected as a flare or ghost phenomenon.

With respect to the flare and ghost phenomena, a strong stray ray, such as the Sun the sky or a lamp, tends to function as the stray ray R_{S} when being incident on the panoramic imaging lens 1 from the 360° circumference.

In the foregoing conventional panoramic imaging system 10, the flare and ghost phenomena adversely affect the preferred imaging ray, which deteriorates the quality of the pictured image.

In addition, illuminations of the panoramic imaging system may vary, such as outdoor, meeting room video and night photographing Different working environments require a different f-number of the panoramic imaging system to ensure good image quality.

However, the aforementioned conventional techniques do not include the aperture 6 with an adjustable aperture size, which results in poor image quality, such as a blurred image due to an under-exposed image such as in night photographing, or and an over-exposed image such as in outdoor photographing.

### SUMMARY OF THE INVENTION

Accordingly, the present invention has been developed considering the foregoing problems associated with conventional techniques, and provides a panoramic imaging lens capable of reducing the complexity and cost of manufacturing, and a panoramic imaging system using the panoramic imaging lens.

The present invention also provides a panoramic imaging lens capable of suppressing stray rays causing flare or ghost phenomenon and improving image quality, and a panoramic imaging system using the panoramic imaging lens.

According to an aspect of the present invention, there is provided a panoramic cemented imaging lens including a first lens piece and a second lens piece. The first lens piece includes a first reflective surface which is formed in a convex form on a front surface of the first lens piece around an optical axis and reflects once-reflected rays incident from a second reflective surface, an incident surface which is formed in a convex annular form on the front surface of the first lens piece and allows rays incident from outside of the panoramic cemented imaging lens to pass through the incident surface, and a first rear surface which is formed behind the incident surface and allows rays incident from the incident surface and twice-reflected rays incident from the first reflective surface to pass through the first rear surface and the once-reflected rays to pass through the first rear surface The second lens piece includes a cemented surface which is cemented with an inner surface part of the first rear surface to allow the rays incident from the incident surface and the twice-reflected rays to pass through the cemented surface and the once-reflected rays to pass through the cemented surface, the second reflective surface which is formed in a concave form behind the cemented surface and reflects the rays incident from the incident surface toward the first reflective surface, and a second rear surface which is formed behind the cemented surface and allows the twice-reflected rays to pass through the second rear surface.

According to another aspect of the present invention, there is provided a panoramic cemented imaging lens including a first lens piece and a second lens piece. The first lens piece includes a first reflective surface in a convex form which is located on a front surface of the first lens piece around an optical axis and reflects once-reflected rays incident from a second reflective surface, an incident surface which is formed in a convex annular form on the front surface of the first lens piece and allows rays incident from outside of the panoramic cemented imaging lens to pass through the incident surface from a 360° azimuth angle and an elevation angle with respect to the optical axis, and a first rear surface which is formed behind the incident surface and allows rays incident from the incident surface and twice-reflected rays incident from the first reflective surface to pass through the first rear surface and the once-reflected rays to pass through the first rear surface. The second lens piece includes a cemented surface which is cemented with an inner surface part of the first rear surface to allow the rays incident from the incident surface and the twice-reflected rays to pass through the cemented surface and the once-reflected rays to pass through the cemented surface, the second reflective surface which is formed in a concave form behind the cemented surface and reflects the rays incident from the incident surface toward the first reflective surface, a second rear surface which is formed behind the cemented surface and allows the twice-reflected rays to pass through the second rear surface, and a cylindrical sidewall surface formed between the cemented surface and the second reflective surface.

According to another aspect of the present invention, there is provided a panoramic cemented imaging system including a panoramic cemented imaging lens, an aperture, and a relay lens part. The first lens piece includes a first reflective surface which is formed in a convex form on a front surface of the first lens piece around an optical axis and reflects once-reflected rays incident from a second reflective surface, a incident surface which is formed in a convex annular form on the front surface of the first lens piece and allows rays incident from outside of the panoramic cemented imaging lens to pass through the incident surface, and a first rear surface which is formed behind the incident surface and allow rays incident from the incident surface and the twice-reflected rays incident from the first reflective surface to pass through the first rear surface and the once-reflected rays to pass through the first rear surface. The second lens piece includes a first reflective surface which is formed in a convex form on a front surface of the first lens piece around an optical axis and reflects once-reflected rays incident from a second reflective surface, a incident surface which is formed in a convex annular form on the front surface of the first lens piece and allows rays incident from outside of the panoramic cemented imaging lens to pass through the incident surface, and a first rear surface which is formed behind the incident surface and allow rays incident from the incident surface and the twice-reflected rays incident from the first reflective surface to pass through the first rear surface and the once-reflected rays to pass through the first rear surface. The aperture passes rays provided from the panoramic cemented imaging lens. The relay lens part corrects residual aberration of the ray passing through the aperture and generates a real image on an imaging element.

### BRIEF DESCRIPTION OF THE DRAWINGS

The above and other aspects, features and advantages of embodiments of the present invention will be more apparent from the following detailed description taken in conjunction with the accompanying drawings, in which:

FIG. 1 illustrates the principle of a conventional panoramic imaging lens;

FIG. 2 illustrates a relationship between the conventional panoramic imaging system shown in FIG. 1 and a formed image;

FIG. 3 illustrates the manner in which flare and ghost phenomena are generated in a panoramic imaging system shown in FIG. 1;

FIG. 4 illustrates a panoramic imaging lens according to an embodiment of the present invention;

FIG. 5 illustrates the manner in which a panoramic imaging lens according to an embodiment of the present invention blocks stray rays;

FIG. 6 illustrates the manner in which a panoramic imaging lens according to an embodiment of the present invention blocks other stray rays;

FIG. 7 illustrates the manner in which an aperture size of a second reflective surface is determined according to an embodiment of the present invention;

FIGS. 8A and 8B compare an astigmatic aberration of a panoramic cemented imaging lens according to an embodiment of the present invention with that of a conventional non-cemented panoramic imaging lens of a single structure;

FIGS. 9A and 9B compare a longitudinal spherical aberration of a panoramic cemented imaging lens according to an embodiment of the present invention with that of a conventional non-cemented panoramic imaging lens of a single structure;

FIG. 10 illustrates a panoramic imaging lens according to an embodiment of the present invention; and

FIG. 11 illustrates a panoramic imaging lens system according to an embodiment of the present invention.

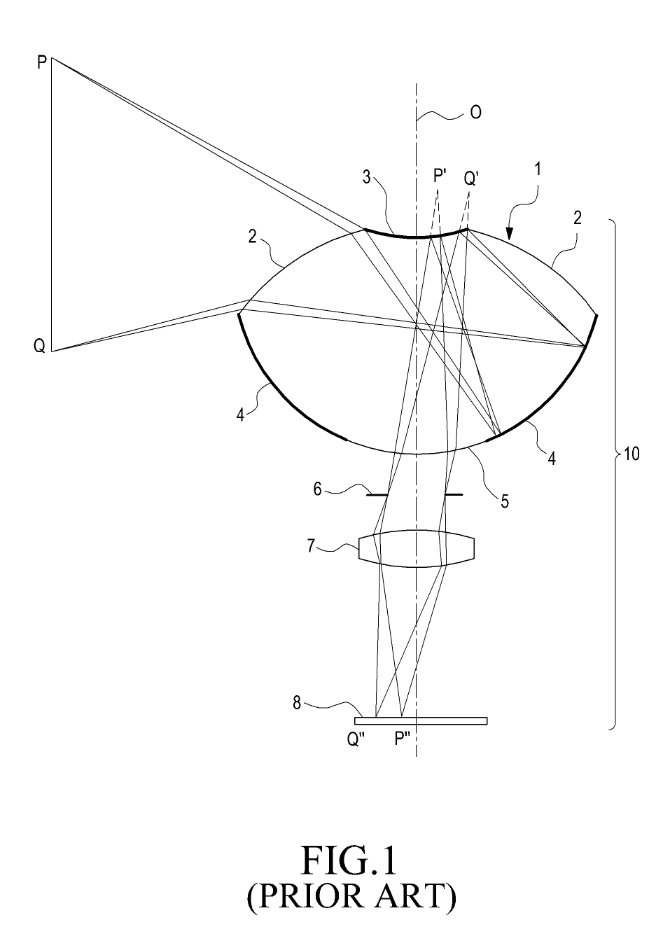

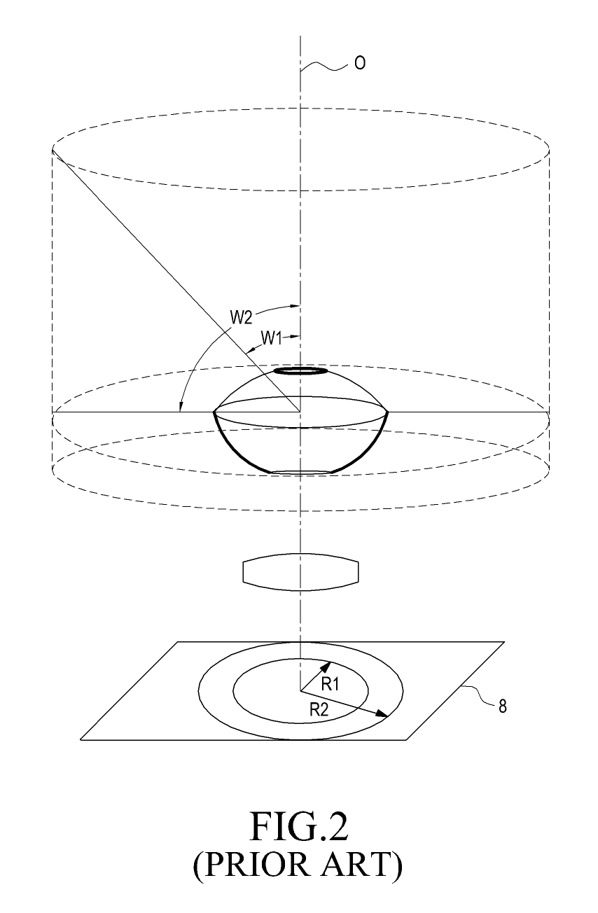

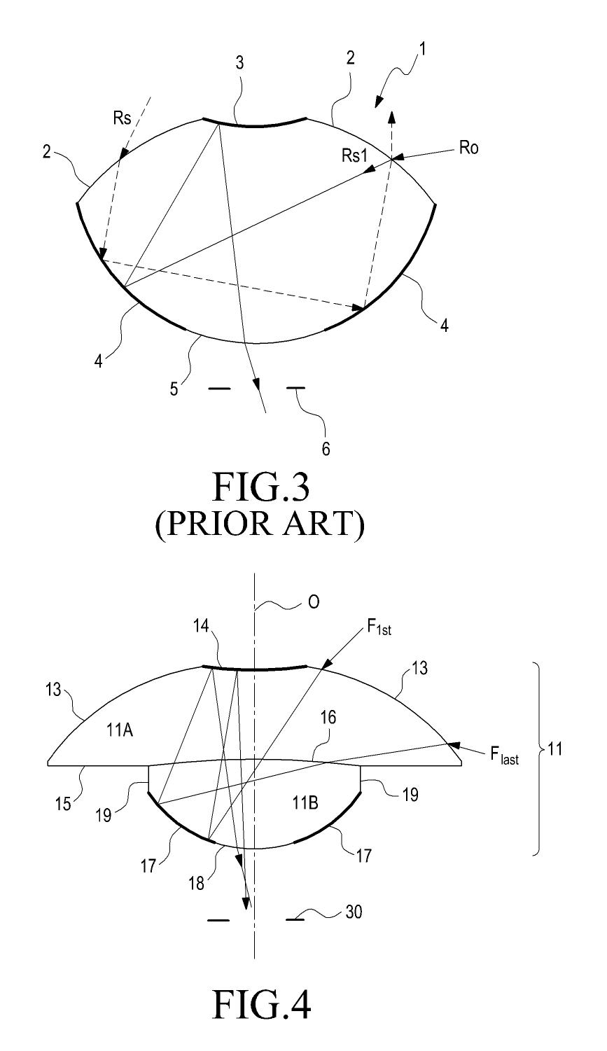

### DETAILED DESCRIPTION OF EMBODIMENTS OF THE INVENTION

Hereinafter, embodiments of the present invention will be described in detail with reference to the accompanying drawings. In the following description, specific details such as detailed configuration and components are merely provided to assist the overall understanding of embodiments of the present invention. Therefore, it should be apparent to those skilled in the art that various changes and modifications of the embodiments described herein can be made without departing from the scope and spirit of the invention. In addition, descriptions of well-known functions and constructions are omitted for the sake of clarity and conciseness.

It is noted that specific values are provided in the present invention, but these values do not limit the present invention unless disclosed in the claims.

A lens according to an embodiment of the present invention may be used for a video camera as well as a still camera.

FIG. 4 illustrates a panoramic imaging lens according to an embodiment of the present invention.

As shown in FIG. 4, a panoramic imaging lens 11 is formed rotationally-symmetric with respect to an optical axis O and includes two lens pieces 11A and 11B. The optical axis O is an imaginary line that passes through the center of the panoramic imaging lens 11, and the optical axis coincides with an axis of rotational symmetry about a central portion or whole of the panoramic imaging lens 11.

The lens pieces 11A and 11B of the panoramic imaging lens 11 may be formed of the same or different materials selected from media optically transparent in a wavelength range (visible rays or infrared rays), such as optical glass and transparent resin.

In FIG. 4, the first lens piece 11A includes a first refractive surface or ray incident surface 13 in an annular form and a first inner reflective surface 14 located in a center part of the annular first refractive surface 13 on a front surface, and a cemented surface 16 located in an inner center part of a rear surface, i.e., a first rear surface 15.

The first refractive surface 13 is formed in a convex form by bulging outwardly from the first lens piece 11A, and accepts lateral rays incident from a 360° azimuth angle with respect to the optical axis O and elevation angles in a designed range from the optical axis O.

The first inner reflective surface 14 is located in the center part of the annular first refractive surface 13, extends from the first refractive surface 13, and is concave toward an inner part of the first lens piece 11A.

Thus, the first inner reflective surface 14 forms a convex mirror inside the first lens piece 11A.

An upper limited elevation angle and a lower limited elevation angle among the elevation angles in the designed range correspond to the nearest field of angle f₁ₛₜ and the farthest field of angle Fₗₐₛₜ with respect to the optical axis O among field of angles formed by the first refractive surface 13.

The first rear surface 15 extends from the other end of the first refractive surface 13, and a center part thereof is concave-recessed to form the cemented surface 16.

The cemented surface 16 is cemented with the second lens piece 11B.

A region on the first rear surface 15, except for the cemented surface 16, i.e., an annular region surrounding the cemented surface 16, may be formed in a dark color by being painted in black to absorb light and thus prevent reflection of the light.

In FIG. 4, the annular region surrounding the cemented surface 16 on the first rear surface 15 is in a flat shape perpendicular to the optical axis O, for example.

However, the first rear surface 15 may also be formed in a concave shape or a convex shape as well as in a flat shape perpendicular to the optical axis O, as long as the cemented surface 16 is in a concave shape.

Cementing between the first lens piece 11A and the second lens piece 11B may use a transparent UltraViolet (UV) adhesive which is hardened when UV rays are applied thereto.

By applying a small amount of UV adhesive onto the cemented surface 16, a thin film of the UV adhesive may be formed.

Once the UV rays are applied onto the cemented surface 16 onto which the UV adhesive is applied, the first lens piece 11A and the second lens piece 11B may be cemented with each other.

The second lens piece 11B includes a second inner reflective surface 17 in an annular form and a second refractive surface (ray outgoing surface) 18 located in a center part of the annular second inner reflective surface 17 on a front surface, and a second rear surface 16 cemented with the cemented surface 16 of the first lens piece 11A.

In the lens 11 shown in FIG. 4, the cemented surface 16 of the first lens piece 11A and the second rear surface 16 of the second lens piece 11B are cemented with each other, and the cemented surface and the second rear surface are indicated by the same reference numeral in the figures and in the following description.

The second inner reflective surface 17 is formed in a convex form by bulging outwardly from the second lens piece 11B.

Thus, the second inner reflective surface 17 forms a concave mirror inside the second lens piece 11B.

The second inner reflective surface 17 is formed in a position in which the second inner reflective surface 17 and the first refractive surface 13 face each other.

The second rear surface 16 is formed in a convex form bulging outwardly to correspond to the concave cemented surface 16 of the first lens piece 11A.

The embodiment of the cemented surface 16 shown in FIG. 4 is in a form bulging outwardly with respect to the second rear surface 16, but the cemented surface 16 may also be in a form recessed inwardly with respect to the second rear surface 16 according to a structure of the panoramic imaging lens 11.

If the cemented surface 16 is not a flat surface, the following effects can be obtained.

When the first lens piece 11A and the second lens piece 11B are formed of different materials and the cemented surface 16 is designed in a spherical form, the aberration of rays passing through the cemented surface 16 may be reduced.

When the first lens piece 11A and the second lens piece 11B are cemented with each other, because they are both in the same spherical form, a center of the first lens piece 11A and a center of the second lens piece 11B can be easily matched, thus simplifying assembly.

The first refractive surface 13 accepts annular rays from distant objects of a scene of a 360° azimuth angle with respect to the optical axis O and elevation angles in a designed range with respect to the optical axis O, i.e., between the first field of angle f₁ₛₜ and the last field of angle Fₗₐₛₜ, and provides the annular rays to the second reflective surface 17 through the cemented surface 16. The first refractive surface 13 allows the annular rays incident from outside of panoramic imaging lens 11 to pass through the first refractive surface 13.

The second reflective surface 17 reflects the annular rays in the lens 11 to provide the annular rays to the first reflective surface 14 through the cemented surface 16.

Then, the first reflective surface 14 reflects back the annular rays (i.e., once-reflected rays) reflected by the second reflective surface 17 to provide the annular rays outside the lens 11 through the cemented surface 16 and the second refractive surface 18.

Thus, the annular rays incident to the first refractive surface 13 are reflected by the second reflective surface 17 and the first reflective surface 14, and then the twice-reflected rays pass through the second refractive surface 18, thus being provided to a relay lens part (not shown) through an aperture (not shown).

When rays propagate from a lens piece to another lens piece in the lens 11, reflection occurring at the cemented surface 16 complies with the Fresnel equation given in Equation (1) by:

$${R}_{S} = {[ \frac{{n}_{1} cos {θ}_{i} - {n}_{2} \sqrt{1 - {( \frac{{n}_{1}}{{n}_{2}} sin {θ}_{i} )}^{2}}}{{n}_{1} cos {θ}_{i} + {n}_{2} \sqrt{1 - {( \frac{{n}_{1}}{{n}_{2}} sin {θ}_{i} )}^{2}}} ]}^{2} \qquad ( 1 )$$

where R_{S} indicates a reflection coefficient, n₁ indicates a refractive index of a transparent medium from which rays are incident, n₂ indicates a refractive index of a transparent medium for which rays head, and θᵢ indicates an incident angle of a ray at the cemented surface 16.

The reflection coefficient R_{S} has a positive value when materials of lens pieces are different from each other, and has a value of 0 when the materials of the lens pieces are identical. As the reflection coefficient R_{S} decreases, the rate of reflected rays decreases.

To reduce the reflection coefficient R_{S} and prevent total internal reflection at the cemented surface 16, a refractive index of panoramic cemented imaging may be given in Equation (2) by:

0≦|Iᵢ−Iⱼ|≦0.3; i, jε1, 2, . . . , k (2)

where k indicates a total number of lens pieces and Iᵢ and Iⱼ represent refractive index values of lens pieces i and j.

To reduce the reflection coefficient R_{S} and prevent total internal reflection at the cemented surface 16, a curvature of the cemented surface 16 may be given in Equation (3) by:

|C_{cemented}|<min(|C₁ₛₜ_{_{—}}_{refractive}|,|C_{2nd}_{_{—}}_{refractive}|); (3)

According to Equation 3, an absolute value of a curvature C_{cemented} of the cemented surface 16 may be smaller than a minimum value between a curvature C₁ₛₜ_{_{—}}_{refractive} of the first refractive surface 13 and a curvature C_{2nd}_{_{—}}_{refractive} of the second refractive surface 18.

By using a cemented lens structure, instead of a single lens element structure in the panoramic imaging lens, and using the following additional structure, important effects can be obtained.

First, the two transparent surfaces 13 and 18 and the two reflective surfaces 14 and 17 included in the panoramic imaging lens 11 are in a spherical form, thereby reducing cost and simplifying and improving accuracy in the fabrication and assembly, due to more lenient tolerances.

In contrast, in the aforementioned conventional techniques, a single lens element structure having four different surfaces, some of which are aspherical mirrors, results in high cost and low accuracy in fabrication and assembly, due to a constraining tolerance for each surface.

In the fabrication process of embodiments of the present invention, the first lens piece 11A and the second lens piece 11B may be formed by grinding optical glass or by injection using transparent resin.

Reflective materials, such as silver, aluminum, gold, or copper, may be coated onto positions where the reflective surfaces 14 and 17 shown in FIG. 4 are located on the transparent refractive surfaces of the first and second lens pieces 11A and 11B formed as described above, thereby manufacturing the reflective surfaces 14 and 17.

When the second reflective surface 17 and the second refractive surface 18 have the same radius and belong to one surface, the second lens piece 11B is more easily manufactured.

Second, by including the lens pieces 11A and 11B having different aperture sizes (i.e., widths) in the panoramic imaging lens 11, stray rays causing flare or ghost phenomenon are suppressed.

A description will now be made of a function of blocking the stray rays causing a ghost or flare phenomenon on the imaging surface.

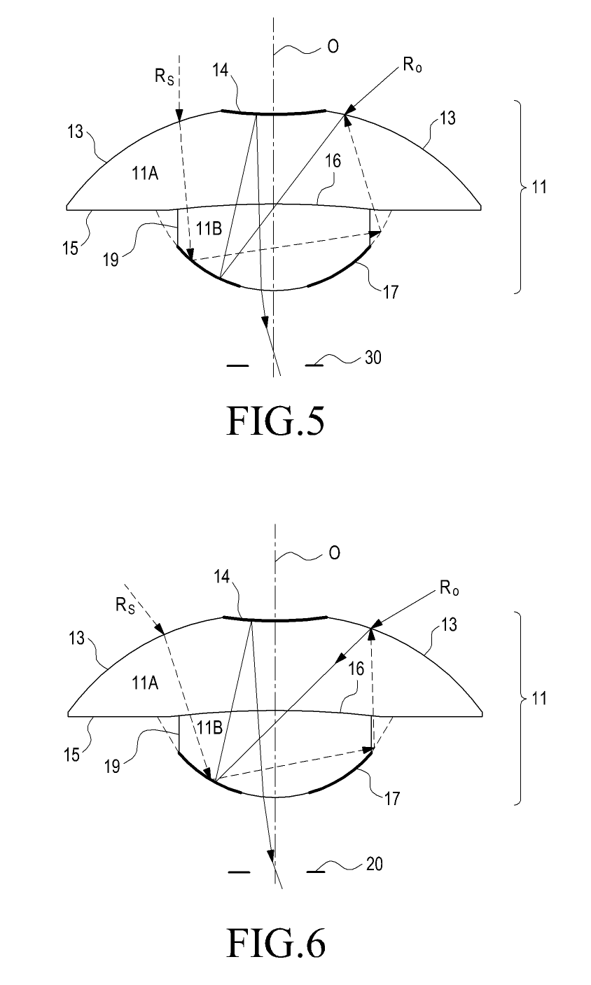

FIGS. 5 and 6 illustrate the manner in which the panoramic imaging lens 11 according to an embodiment of the present invention blocks stray rays.

As shown in FIG. 5, the stray ray R_{S} is incident to the ray incident surface 13 of the panoramic cemented imaging lens 11, and after the stray ray R_{S} is twice reflected on the second reflective surface 17 in the panoramic cemented imaging lens 11, most of the stray ray R_{S} is emitted through the ray incident surface 13.

However, a part of the stray ray R_{S} is reflected inwardly on the ray incident surface 13 in the panoramic cemented imaging lens 11 and propagates along the ray path of the regular imaging ray R_{O} of the lens 11.

As a result, the stray ray R_{S1}, which is the part of the stray ray R_{S}, is reflected inwardly on the ray incident surface 13, and then agrees with the ray path of the regular imaging ray R_{O} to reach the imaging element (not shown) and is projected as a flare or ghost phenomenon.

FIG. 6 illustrates a similar situation in which the stray ray R_{S} having a larger incident angle compared to the embodiment shown in FIG. 5 is incident to the first refractive surface 13 and refracts on the first refractive surface 13, and after being reflected twice on the second reflective surface 17, the stray ray R_{S} agrees with the ray path of the regular imaging ray R_{O} and thus flare and ghost phenomena are generated.

Such flare and ghost phenomena may be eliminated by simply cutting the aperture of the second lens piece 11B of the panoramic imaging lens 11 as shown in FIGS. 4 through 6.

That is, as shown in FIGS. 5 and 6, by cutting the aperture of the second lens piece 11B, the external aperture of the second reflective surface 17 is reduced, such that the path of the stray ray R_{S} is blocked by the edge of a side 19 of the second lens piece 11B, thereby eliminating the stray ray R_{S} heading for the ray path of the regular imaging ray R_{O} and thus obtaining a clear image having no ghost or flare phenomenon.

In FIGS. 4 through 6, by cutting the aperture of the second lens piece 11B, the cylindrical sidewall surface 19 is formed, which may be parallel with the optical axis O.

The side 19 may be formed in a dark color by being painted in black to absorb light for preventing reflection of the light, and if necessary, the side 19 may be formed as a roughened surface for diffused reflection of the light.

As the aperture size of the second lens piece 11B decreases, the cost of manufacturing of the second lens piece 11B is reduced.

However, the size of the second lens piece 11B is limited by the field of view and should not be arbitrarily reduced.

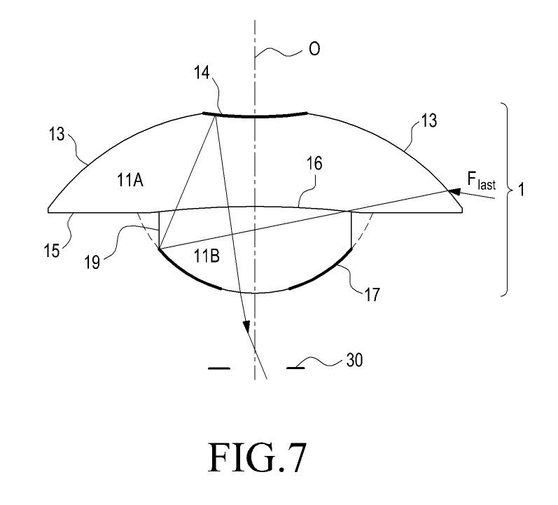

FIG. 7 illustrates the manner in which an aperture size of the second reflective surface 17 is determined according to an embodiment of the present invention.

As shown in FIG. 7, the smallest aperture size of the second lens piece 11B is limited by the ray height of the last field of angle at the second reflective surface 17.

The aperture of the second lens piece 11B should not be cut smaller than the limited aperture value.

That is, a lower end connected to the second reflective surface 17 among both ends of the cylindrical side 19 may be formed to a height of a lower end of the cylindrical side 19 from a lower end of the second lens piece 11B sufficient for allowing the ray incident at the farthest field of angle Fₗₐₛₜ from the optical axis O to reach the second reflective surface 17.

As the width of the second lens piece 11B oriented perpendicularly to the optical axis O increases, the height of a lower end of the cylindrical side 19 oriented in parallel with the optical axis O increases. That is, a width of a cut portion of the second lens piece 11B oriented perpendicularly to the optical axis O decreases, the height of the lower end of the cylindrical side 19 from the lower end of the second lens piece 11B oriented in parallel with the optical axis O increases.

The side 19 may be formed to the maximum height among heights sufficient for allowing the ray incident at the farthest field of angle Fₗₐₛₜ from the optical axis O to reach the second reflective surface 17.

In addition, the cemented lens structure reduces the field curvature, particularly the field curvature aberration at a large field of view, thus simplifying a structure of the relay lens part for correcting the residual aberrations of the image from the panoramic cemented imaging lens and transferring a virtual image to a real image on the imaging element.

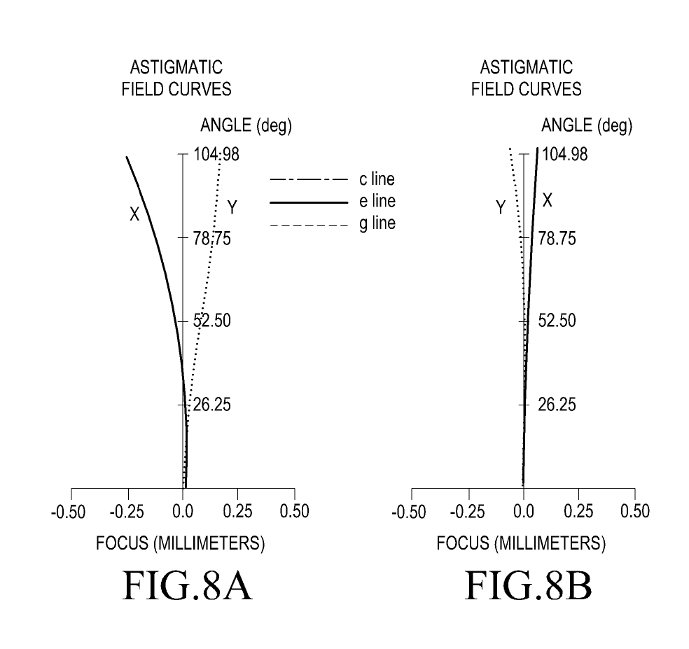

FIG. 8A illustrates an astigmatic aberration of a conventional non-cemented panoramic imaging lens of a single structure, compared with FIG. 8B, which illustrates an astigmatic aberration of a panoramic cemented imaging lens according to an embodiment of the present invention.

In FIGS. 8A and 8B, a solid line X and a dotted line Y indicate astigmatic aberrations on a sagittal plane and a tangential plane, a horizontal axis indicates a coefficient of the astigmatic aberration or the field of curvature and a vertical axis indicates a distance from a center of ray focused on an imaging element 8 to the edge of the ray. That is, the horizontal axis represents the deviation in mm units of the position of the focal point, and the vertical axis represents the incident angle of the ray.

Referring to FIGS. 8A and 8B, a difference between the solid line X and the dotted line Y indicates a size of the astigmatic aberration and the degree of bend of the line indicates the field of curvature.

The astigmatic aberration of the panoramic cemented imaging lens according to the embodiment shown in FIG. 8B is much smaller than that of the conventional non-cemented panoramic imaging lens of the single structure shown in FIG. 8A, particularly at a large field of view.

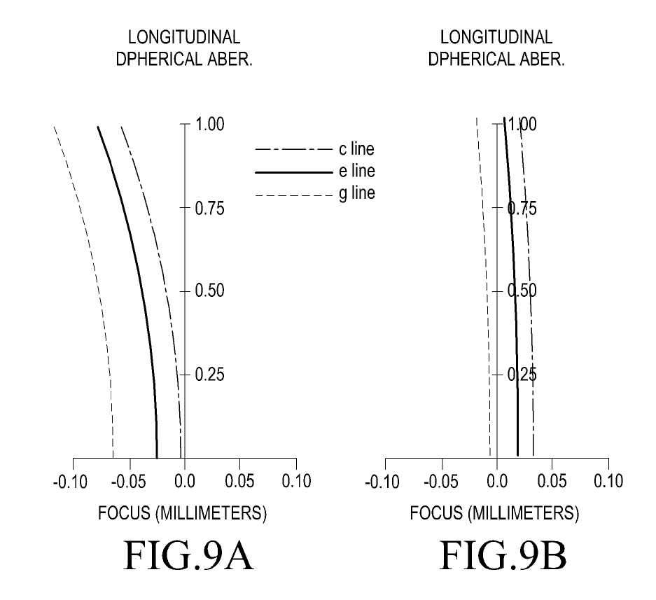

FIG. 9A illustrates a longitudinal spherical aberration of the conventional non-cemented panoramic imaging lens of the single structure, compared with FIG. 9B, which illustrates a longitudinal spherical aberration of the panoramic cemented imaging lens formed to have a plurality of lens pieces according to an embodiment of the present invention.

In FIGS. 9A and 9B, a horizontal axis indicates a coefficient of a longitudinal spherical aberration and a vertical axis indicates a normalized distance from the center of ray focused on the imaging element 8 to the edge of the ray. That is, the horizontal axis represents the deviation in mm units of the position of the focal point, and the vertical axis represents an incidence height of the ray normalized by the maximum incidence height.

FIGS. 9A and 9B show spherical aberrations with respect to wavelengths, in which a dotted line and two types of dotted lines indicate longitudinal spherical aberrations with respect to e, g, and C lines, respectively.

When the panoramic cemented imaging lens 11 according to an embodiment of the present invention has the plurality of lens pieces 11A and 11B, which adopt different transparent materials, several advantages are realized in correction of a spherical aberration caused by the panoramic imaging lens as indicated by a wavelength graph (e, g, and c lines) in FIG. 9B.

As shown in FIG. 9B, a panoramic cemented imaging lens using two lens pieces has a smaller longitudinal spherical aberration than the single-piece panoramic imaging lens shown in FIG. 9A.

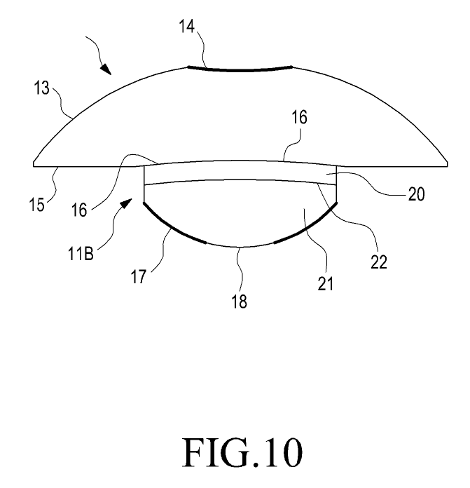

FIG. 10 illustrates a panoramic imaging lens according to an embodiment of the present invention. As shown in FIG. 10, the second lens piece 11B may also be formed by cementing a plurality of sub lens pieces 20 and 21 to each other.

The plurality of sub lens pieces 20 and 21 are arranged on the optical axis O and are cemented to each other by using a cementing liquid.

A cemented surface 22 between the sub lens pieces 20 and 21 is formed to bulge toward the first lens piece 11A.

The curvature of the cemented surface 22 is smaller than the curvatures of the first refractive surface 13 and the second reflective surface 17.

The first lens piece 11A and the first sub lens piece 20 may be formed using different transparent materials.

The first sub lens piece 20 and the second sub lens piece 21 may be formed using different transparent materials.

An absolute value of a difference between refractive indices of the two adjacent lens pieces may be set to 0.3 or lower as in Equation 2.

As such, by forming the two adjacent lens pieces with different transparent materials, the chromatic aberration is reduced when compared to the embodiment shown in FIG. 4, in the following manner.

Adjacent pieces formed of different materials have different Abbe numbers at the d-line.

One of the pieces formed of different materials may have a low Abbe number (=distribution value) and the other piece may have a high Abbe number, thus reducing the chromatic aberration.

Although the second lens piece 11B is formed of the two sub lens pieces 20 and 21 in FIG. 10, it may also be formed by cementing two or more sub lens pieces to one another.

The rays from the distant objects of the scene of a 360° azimuth angle and a designed elevation angle pass through the panoramic cemented imaging lens 11, thereby passing through an aperture 30 located directly behind the panoramic cemented imaging lens 11 and entering the relay lens part 40.

The relay lens part 40 corrects the residual aberration and generates a real image on the imaging element.

The panoramic cemented imaging lens 11, the aperture 30, and the relay lens part 40 constitute a panoramic imaging system used for applications such as photographing, navigation and surveillance.

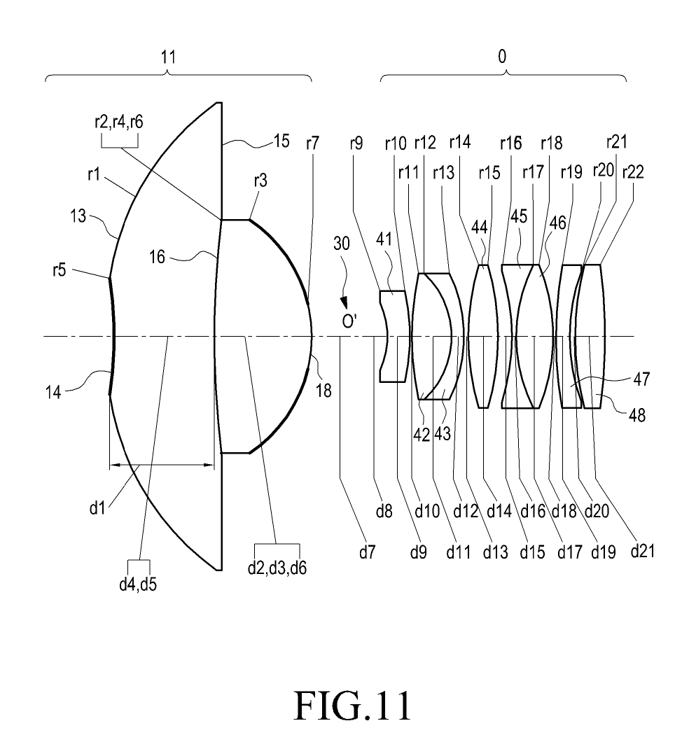

FIG. 11 illustrates a panoramic imaging lens system according to an embodiment of the present invention.

As shown in FIG. 11, the panoramic imaging lens system includes the panoramic cemented imaging lens 11, the aperture 30, and the relay lens part 40 arranged in this order from an object and may have a field of angle from 45° to 105°, which allows the system to have a field of view of [45,105]×360.

The panoramic cemented imaging lens 11 of the embodiment shown in FIG. 11 includes the first lens piece 11A having three lens surfaces.

One of the three surfaces of the first lens piece 11A is an annular convex surface 13 having the maximum aperture for receiving a large field of angles, and another surface among them is a symmetric blind hole 14 in a center part of the annular convex surface 13.

The blind hole 14 is in a concave shape and a convex mirror surface is formed in an inner surface of the lens 11.

The last surface 15 among the three surfaces is the first rear surface 15 for cementing the second lens piece 11B, in a center part of which is formed the cemented surface 16.

The second lens piece 11B also includes three lens surfaces, one of which is an annular concave mirror surface 17 and another of which is a symmetric transparent region 18 in a center part of the annular concave mirror surface 17.

A convex surface is located on the symmetric transparent region 18.

Among the three surfaces of the second lens piece 11B, the third surface 16 is a convex surface 16 for cementing with the first lens piece 11A.

The aperture 30 has an aperture size which allows the panoramic imaging system to reach an f-number of 3.22, and this aperture size is adjustable automatically using Transistor-Transistor Logic (TTL) light measuring, or manually, to ensure the adaptability of the panoramic imaging system to different illuminant situations, such as outdoor, meeting room video, and night photographing.

The f-number of 3.22 ensures successful operation of the panoramic imaging system under low illuminant situations, and by increasing the f-number up to, for example, 22, the panoramic imaging system has a high image quality under high illuminant situations.

The relay lens part 40 includes a meniscus negative lens element 41 having a concave surface facing toward the object, a cemented lens element having a positive biconvex lens element 42 and a meniscus negative lens 43 having the concave surface facing toward the object, a biconvex lens element 44, a cemented lens element having a biconcave negative lens element 45 and a biconvex positive lens element 46, a meniscus lens element 47 having a convex surface facing toward the object, and a biconvex positive lens element 48.

The negative meniscus lens element 41 located closest to the object is provided with two aspherical surfaces, and the biconvex positive lens element 48 located closest to the image is also provided with two aspherical surfaces.

Table 1 and Table 2 below show numerical data of the panoramic imaging system.

In Table 1, FNO designates the smallest possible f-number, f designates the focal length of the panoramic imaging system, W designates the ½ angle-of-view (degree), r designates the radius of curvature, d designates the lens-element thickness or a distance between lens elements, N_{d} designates the refractive index of the d-line (587.5618 nm), and v designates the Abbe number, wherein a unit of the radius of curvature and the thickness is mm. The focal length is the distance over which initially collimated light is brought to a focus.

In addition, the f-number in the panoramic imaging system without an on-axis image is defined in Equation (4) as follows:

$$FNO = \frac{1}{2 {n}^{′} sin ( \frac{\vert A 1 - A 2 \vert}{2} )} \qquad ( 4 )$$

wherein n′ designates a refractive index of an image space, A1 is the image plane incident angle of the upper marginal ray of the first field of angle, and A2 is the image plane incident angle of the lower marginal ray of the first field of angle.

An aspherical surface which is symmetrical with respect to the optical axis is defined in Equation (5) as follows.

$$x = \frac{{cy}^{2}}{\sqrt{1 + [ 1 - ( 1 + k ) {c}^{2} {y}^{2} ]}} + {A}_{4} {y}^{4} + {A}_{6} {y}^{6} + {A}_{8} {y}^{8} + {A}_{10} {y}^{10} \qquad ( 5 )$$

In Equation (5), c designates a reciprocal of the radius of curvature (1/r) at the vertex of the lens, x designates a distance from the vertex or center of the lens along the optical axis, y designates a distance in perpendicular to the optical axis, K designates a conic constant, A₄ designates a fourth-order aspherical constant, A₆ designates a sixth-order aspherical constant, A₈ designates an eighth-order aspherical constant, and A₁₀ designates a tenth-order aspherical constant.

TABLE 1
FNO = 1: 3.22; f = −4.22; W = [45,105] × 360

| Surf. No. | r | d | Nd | v |
|---|---|---|---|---|
| 1 | 44.628 | 17.190 | 1.519 | 64.197 |
| 2 | 143.361 | 14.700 | 1.555 | 63.333 |
| 3(Reflect) | −21.750 | −14.700 | −1.555 | 63.333 |
| 4 | 143.361 | −15.490 | −1.519 | 64.197 |
| 5(Reflect) | −76.056 | 15.490 | 1.519 | 64.197 |
| 6 | 143.361 | 14.700 | 1.555 | 63.333 |
| 7 | −21.750 | 5.400 | | |
| STO | infinity | 2.800 | | |
| 9* | −9.539 | 3.500 | 1.606 | 57.400 |
| 10* | −22.743 | 0.380 | | |
| 11 | 54.268 | 5.740 | 1.498 | 81.607 |
| 12 | −12.346 | 2.000 | 1.792 | 25.720 |
| 13 | −20.862 | 0.600 | | |
| 14 | 36.568 | 4.360 | 1.816 | 22.760 |
| 15 | −42.459 | 2.130 | | |
| 16 | −38.176 | 1.000 | 1.792 | 25.720 |
| 17 | 22.448 | 5.690 | 1.498 | 81.607 |
| 18 | −26.188 | 0.380 | | |
| 19 | 62.244 | 2.000 | 1.704 | 30.050 |
| 20 | 26.916 | 0.790 | | |
| 21* | 42.535 | 4.500 | 1.805 | 40.900 |
| 22* | −87.816 | | | |

TABLE 2

| Surf. No. | k | A4 | A6 |
|---|---|---|---|
| 9* | −2.24 | −4.86E−05 | 6.69E−07 |
| 10* | −2.99 | 1.33E−04 | −1.88E−7 |
| 21* | 2.61 | −7.81E−06 | 1.73E−08 |
| 22* | −55.09 | −7.21E−06 | 6.56E−08 |

Table 2 shows aspherical surface data.

In Table 1, a symbol * designates an aspherical surface which is rotationally symmetrical with respect to the optical axis, and a lens having no symbol * added to the surface number is formed as a rotationally symmetrical spherical surface. The surface number 3 (Reflect) designates the first inner reflective surface 14, the surface number 5 (Reflect) designates the second inner reflective surface 17, r1 through r22 designates surfaces of related lenses, STO designates the aperture 30, and d1 through d21 designate thicknesses of the related lenses or distances between the related lenses.

According to the present invention, the complexity and cost of manufacturing the panoramic imaging lens is reduced, and stray ray causing a flare or ghost phenomenon is suppressed in the panoramic imaging system, thereby improving image quality.

While the present invention has been shown and described with reference to embodiments thereof, it will be understood by those skilled in the art that various changes in form and details may be made therein without departing from the scope of the present invention as defined by the appended claims and their equivalents.

What is claimed is:

1. A panoramic cemented imaging lens comprising:
a first lens piece comprising:
a first reflective surface which is formed in a convex form on a front surface of the first lens piece around an optical axis and reflects once-reflected rays incident from a second reflective surface;
an incident surface which is formed in a convex annular form on the front surface of the first lens piece and allows rays incident from outside of the panoramic cemented imaging lens to pass through the incident surface; and
a first rear surface which is formed behind the incident surface and allows rays incident from the incident surface and twice-reflected rays incident from the first reflective surface to be transmitted through the first rear surface and the once-reflected rays to pass through the first rear surface; and
a second lens piece comprising:
a cemented surface which is cemented with an inner surface part of the first rear surface to allow the rays incident from the incident surface and the twice-reflected rays to pass through the cemented surface and the once-reflected rays to pass through the cemented surface;
the second reflective surface which is formed in a concave form behind the cemented surface and reflects the rays incident from the incident surface toward the first reflective surface; and
a second rear surface which is formed behind the cemented surface and allows the twice-reflected rays to pass through the second rear surface.

2. The panoramic cemented imaging lens of claim 1, wherein the first lens piece is formed of a single material, and the second lens piece is formed of a material different from that of the first lens piece.

3. The panoramic cemented imaging lens of claim 1, wherein the first reflective surface and the second reflective surface are mirror-surface-treated to be mirrors.

4. The panoramic cemented imaging lens of claim 1, wherein a cylindrical sidewall surface which is parallel with the optical axis is provided between the cemented surface and the second reflective surface which form the second lens piece.

5. The panoramic cemented imaging lens of claim 1, wherein between the cemented surface and the second reflective surface is provided a cylindrical sidewall surface which absorbs or diffuse-reflects stray rays incident from the incidence surface.

6. The panoramic cemented imaging lens of claim 5, wherein the sidewall surface has a height that allows a ray incident at the farthest field of angle from the optical axis to reach the second reflective surface.

7. The panoramic cemented imaging lens of claim 5, wherein a region except for the inner surface part on the first rear surface and the sidewall surface are painted in a dark color.

8. The panoramic cemented imaging lens of claim 1, wherein the inner cemented part of the first rear surface is formed in a concave form, the cemented surface is formed in a convex form, and the inner cemented part of the first rear surface and the cemented surface are cemented with each other by an adhesive.

9. The panoramic cemented imaging lens of claim 1, wherein a curvature of the incident surface is smaller than a curvature of the second reflective surface.

10. The panoramic cemented imaging lens of claim 1, wherein the incident surface and the second reflective surface are spherically formed, and a curvature of the incident surface is smaller than a curvature of the second reflective surface.

11. The panoramic cemented imaging lens of claim 1, wherein the incident surface, the first reflective surface, the second reflective surface, the second rear surface, and the cemented surface are spherically formed.

12. The panoramic cemented imaging lens of claim 1, wherein the second reflective surface and the second rear surface have identical curvatures.

13. The panoramic cemented imaging lens of claim 1, wherein an absolute value of a difference between a refractive index value of the first lens piece and a refractive index value of the second lens piece is smaller than 0.3.

14. The panoramic cemented imaging lens of claim 1, wherein a curvature of the cemented surface is smaller than a curvature of the incident surface and a curvature of the second reflective surface.

15. The panoramic cemented imaging lens of claim 1, wherein the second lens piece is formed by cementing a plurality of sub lens pieces with one another.

16. The panoramic cemented imaging lens of claim 15, wherein a curvature of a cemented surface between the sub lens pieces is smaller than a curvature of the incident surface and a curvature of the second reflective surface.

17. A panoramic cemented imaging lens comprising:
a first lens piece comprising:
a first reflective surface in a convex form which is located on a front surface of the first lens piece around an optical axis and reflects once-reflected rays incident from a second reflective surface;
a incident surface which is formed in a convex annular form on the front surface of the first lens piece and allows rays incident from outside of the panoramic cemented imaging lens to pass through the incident surface from a 360° azimuth angle and an elevation angle with respect to the optical axis; and
a first rear surface which is formed behind the incident surface and allows rays incident from the incident surface and twice-reflected rays incident from the first reflective surface to pass through the first rear surface and the once-reflected rays to pass through the first rear surface; and
a second lens piece comprising:
a cemented surface which is cemented with an inner surface part of the first rear surface to allow the rays incident from the incident surface and the twice-reflected rays to pass through the cemented surface and the once-reflected rays to pass through the cemented surface;
the second reflective surface which is formed in a concave form behind the cemented surface and reflects the rays incident from the incident surface toward the first reflective surface;
a second rear surface which is formed behind the cemented surface and allows the twice-reflected rays to pass through the second rear surface; and
a cylindrical sidewall surface formed between the cemented surface and the second reflective surface,
wherein the sidewall surface has a height that allows a ray incident at the farthest elevation angle from the optical axis to reach the second reflective surface.

18. The panoramic cemented imaging lens of claim 17, wherein the first reflective surface, the second reflective surface, the second rear surface are spherically formed, a curvature of the incident surface is smaller than a curvature of the second incident surface, and the sidewall and a region except for the inner surface part on the first rear surface are painted in a dark color.

19. A panoramic cemented imaging system comprising:
a panoramic cemented imaging lens comprising:
a first lens piece comprising:
a first reflective surface which is formed in a convex form on a front surface of the first lens piece around an optical axis and reflects once-reflected rays incident from a second reflective surface;
a incident surface which is formed in a convex annular form on the front surface of the first lens piece and allows rays incident from outside of the panoramic cemented imaging lens to pass through the incident surface; and
a first rear surface which is formed behind the incident surface and allow rays incident from the incident surface and the twice-reflected rays incident from the first reflective surface to pass through the first rear surface and the once-reflected rays to pass through the first rear surface; and
a second lens piece comprising:
a cemented surface which is cemented with an inner surface part of the first rear surface and allows the rays incident from the incident surface and the twice-reflected rays to pass through the cemented surface part and the once-reflected rays to pass through the cemented surface;
the second reflective surface which is formed in a concave form behind the cemented surface and reflects the rays incident from the incident surface toward the first reflective surface; and
a second rear surface which is formed behind the cemented surface and allows the twice-reflected rays to pass through the second rear surface;
an aperture through which passes rays provided from the panoramic cemented imaging lens; and
a relay lens part which corrects residual aberration of the ray passing through the aperture and generates a real image on an imaging element.

20. The panoramic cemented imaging system of claim 19, wherein aperture size of the aperture is adjustable automatically using Transistor-Transistor Logic (TTL) light measuring, or is manually adjustable.
